(19) United States
(12) Patent Application Publication
(10) Pub. No.: US 2016/0371673 A1
(43) Pub. Date: Dec. 22, 2016

(54) CHECKOUT LINE PROCESSING BASED ON DETECTED INFORMATION FROM A USER'S COMMUNICATION DEVICE

(71) Applicant: PAYPAL, INC., San Jose, CA (US)

(72) Inventors: David Edward Eramian, Mountain View, CA (US); Michael Charles Todasco, Santa Clara, CA (US); Dushyanth Bharadwaj, Scotts Valley, CA (US); Patrick Wong, San Jose, CA (US); Abhinav Agarwal, Fremont, CA (US)

(21) Appl. No.: 14/743,989

(22) Filed: Jun. 18, 2015

(51) Int. Cl. G06Q 20/32

(52) U.S. Cl. CPC G06Q 20/32

(57) ABSTRACT

There are provided systems and methods for checkout line processing based on merchant employee familiarity with communication device processes. A user may visit a merchant location and utilize a device payment application of a mobile device for a payment during transaction processing. The merchant's device may determine which merchant employees are most familiar with processing payments using the application, and direct the user to those merchant employees. Where the user has already select one of the merchant employees, but the merchant employee is unfamiliar with the application, the merchant's device may load payment processing instructions, walkthroughs, and interactive interfaces to assist in payment processing. Moreover, based on the merchant employee's familiarity with other payment instruments, the merchant's device may suggest another payment instrument for the user to use during payment processing.

### TECHNICAL FIELD

The present application generally relates to utilizing detecting available communication device processes and assessing merchant employee familiarity with the communication device processes and more specifically to checkout line processing based on detected information from a user's communication device.

### BACKGROUND

A user may utilize a device, such as a mobile phone, tablet computer, or other type of computing device that may include payment applications or other types of processes and features for use as a payment instrument for payment during a transaction. The user may utilize the communication device at a merchant location in order to provide payment at the merchant location, such as through a payment provider that may assist in transferring funds and making payments. However, interactions between the communication device and merchant devices to process the payment may be complicated. For example, the user may be required to navigate menu interfaces and input merchant information, which may be time consuming and difficult if the user is not experienced with the payment application. Moreover, the merchant's employees may be inexperienced with new payment applications, and may require training in order to properly process payments with user's using payment applications. Thus, in order to ensure that the merchant's employees correctly and quickly process payments, the merchant and the payment provider may wish to direct the user to merchant employees having the most experience processing payments using the payment applications.

### BRIEF DESCRIPTION OF THE DRAWINGS

FIG. 1 is a block diagram of a networked system suitable for implementing the processes described herein, according to an embodiment;

FIG. 2 is an environment where merchant employees may receive instructions for payment processing using payment instruments and users may be guided to a specific merchant checkout lines based on their payment instruments, according to an embodiment;

FIG. 3 is an exemplary interaction between a communication device, a payment provider server, and a merchant device for determining a checkout line to direct a user for payment processing, according to an embodiment;

FIG. 4 is a flowchart of an exemplary process for checkout line processing based on detected information from a user's communication device, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for checkout line processing based on detected information from a user's communication device. Systems suitable for practicing methods of the present disclosure are also provided.

A user may utilize a communication device at various locations where a user may provide payment using processes and features of the communication device, including merchant locations, transportation hubs/terminals, venues for events, travel destinations, or other places where a user may utilize the communication device. For example, the communication device may include a payment application and associated communication hardware that may be used to provide payments to the merchant at the location. The merchant may further include merchant devices at the merchant location, which may interact with the communication device to effectuate a payment. The merchant devices may be located at a checkout location within the merchant location, which may have one or more checkout lines where the user can initiate a transaction and complete payment for the transaction using the communication device. The checkout lines may each have a merchant employee that may assist the user in completing the transaction by utilizing one of the merchant devices located at the checkout line to process a payment with the communication device.

As the user approaches the checkout location, the user may be detected as at or nearby the checkout location and ready to initiate a transaction and process a payment for the transaction. The user may be detected at or approaching the checkout location using short range wireless communications between the communication device and another device at the merchant location, including the merchant devices and/or a wireless beacon using short range wireless communications with the user's communication device. For example, as the user approaches the checkout location, the communication device may pair with the device(s) using the short range wireless communications, such as near field communications, Bluetooth communications, Bluetooth Low Energy communication, LTE Direct communications, or other communication protocol. Once paired, the communication device may provide user information to the paired device that identifies the user and allows the device to detect that the user is at or nearby the checkout location. In other embodiments, the user may be detected at or nearby the checkout location based on a location detection module of the communication device, such as a mapping or GPS module. Thus, the merchant device may determine that the user is at the checkout location when receiving user information that identifies the user as located at or nearby the checkout location.

The user may wish to use a payment instrument at the merchant's checkout location, such as a payment application on the communication device and offered by a payment provider (e.g., an application offered by PAYPAL®, including VENMO, or other vendor including APPLE®). The user may set their preference to use the application, which may be communicated to the merchant's devices and/or server with the user information. In other embodiments, the preference to use the payment application may be scraped from available data for the user (e.g., user information with the payment provider, online behavior, etc.) or based on available processes for the communication device and/or processes the user is currently engaged in on the communication device (e.g., if the payment application is available on the communication device or currently open). Once the desired payment instrument for the user is detected, the merchant's devices/server may determine an optimized checkout line of the plurality of checkout lines at the checkout location to send the user for faster checkout and/or payment processing assistance based on the merchant employees' experience with the payment instrument.

For example, the merchant's devices/server may access merchant employee information for the merchant employees located at the checkout location (e.g., in each of the checkout lines at the checkout location). The merchant employee information may include a familiarity level, rating, score, or other metric for each merchant employee, which may assess how comfortable and familiar the merchant employee is with processing payments using the payment instrument. In this regard, a familiarity level may correspond to how much training a merchant has with processing payments using the payment instrument. The training may be offered by the merchant, or may be offered by the payment provider for the payment instrument. Thus, information about an amount of training may be accessed from a server for the payment provider by the merchant's devices/server. The amount of training may correspond to a number of training classes, a training certification/level (e.g., ranking based on an amount of training), or other training assessment. The familiarity level may also include a number of times the merchant employee has used the payment instrument to process a payment during a transaction, and/or an amount of time the merchant employee requires when processing payments using the payment instrument. The amount of time may be an average over all payment processing, or may be weighted so that if the merchant employee has required less time (e.g., becomes more familiar) to process recent payments using the payment instrument, the familiarity level for the merchant employee with the payment instrument may be increased.

Once the familiarity levels for all the merchant employees located at the plurality of checkout lines is determined, the merchant's devices/server may determine one of the merchant employees having a highest familiarity rating with using the payment instrument for payment processing. The highest familiarity rating may correspond to one of the merchant employees that is the fastest to process payments using the payment instrument (e.g., has the lowest time required to process payments). Additionally, the highest familiarity rating may also or instead be associated the merchant employee with the most training or experience in guiding users through payment processing using the payment instrument and/or troubleshooting issue during payment processing with the payment instrument. In any of the above ratings, the merchant's device may determine that one of the merchant employees would be ideal to process payment for the user. The merchant's devices/server may then determine the checkout line corresponding to that merchant employee, and may direct the user to the checkout line for the merchant employee. The direction may be communicated to the user on the user's communication device, or may be displayed to the user through a display device visible at the checkout location. In various embodiments, the merchant's devices/server may also consider the checkout lines current wait times and/or number of users in the checkout lines when considering which line would be best for the user. Thus, a merchant employee having the second or third highest familiarity level may be selected if a line with the first option is long. Additionally, the notification may be further generated based on each of the checkout lines current resources and/or availability. Thus, if a checkout line's physical payment check processing or communication module for interfacing with the user's communication device is currently offline or otherwise inaccessible, the notification may direct to user to a different checkout line should the user wish to pay through a physical written check or device application, respectively.

In other embodiments, the user may pick a specific checkout line at the checkout location to utilize. The user may additionally have already indicated their preference for a payment instrument to use at the checkout location, as discussed above. The merchant device for the checkout line may then determine a familiarity level for the merchant employee located in the checkout line selected by the user with using the payment instrument preferred by the user. As discussed herein, the familiarity level may correspond to a training assessment level of the merchant employee with using the payment instrument for processing payments. Based on the familiarity level, the merchant device may access and display payment processing instructions to the merchant employee. The payment processing instructions may be available from stored information to the merchant device or accessible over a network connection with the payment provider's server.

The payment processing instructions may correspond to an instructional guide on processing payments using the mobile payment application and/or a payment interface of the merchant device that provides an interactive walkthrough of processing the payment. Where the merchant employee already has experience using the payment instrument for payment processing, the payment processing instructions may also correspond to tips for faster processing time when using the payment instrument and/or a payment interface walkthrough for a corresponding payment application on the merchant device for use with the mobile payment application. Thus, if the merchant employee is unfamiliar with using the payment instrument (e.g., the mobile device application of the communication device), then the merchant employee may be guided on payment processing using the payment instrument. Where the merchant employee is familiar using the payment instrument and wishes to increase processing speed to more quickly process payments, the merchant employee may also receive tips and walkthroughs for processing through the merchant device when the user is checking out with the merchant employee. The payment processing instructions may also be customized for the merchant employee based on the merchant employee's familiarity level. The instructions, tips, and/or walkthroughs could be customized for a merchant employee based on data for the entire process. For example, if we know that merchant employee X is overall the best to perform a checkout/payment process, but completes second part of the checkout process slightly slower than average, the instructions may be customized to coach merchant employee X on that aspect of the checkout/payment process, thereby continuing to improve their overall speed and accuracy

However, if the user has not indicated a preference for one payment instrument, the merchant's device may determine a best payment instrument to utilize for the checkout line that the user has selected. The merchant's device may determine a plurality of payment instruments available to the user while the user is located in a checkout line. The payment instruments may correspond to different payment applications on the communication device, and may also include traditional payment instruments, such as a credit/debit card, cash, check, financial account transfer, or other type of payment instrument. The merchant's device may then determine the merchant employee's familiarity level for each of the payment instruments available to the user. The merchant's device/server may select a payment instrument for use by the user with that the merchant employee has a highest familiarity level with processing. The merchant's device may then alert the user through a notification to user the selected payment instrument based on the user's familiarity level. However, if the user decides to use a different payment instrument (e.g., based on available funds, credit/benefit offers, etc.), the merchant device may alert the merchant employee and provider payment processing instructions if necessary. Moreover, in certain embodiments, the notification may be further based on the checkout capabilities of the checkout line the user is presently located in. Thus, if the checkout line is low on cash or unable to process a payment using a communication device application, the notification may alert the user that a certain payment instrument is recommended and/or required by the checkout line. In such embodiments, past user actions indicative of a payment instrument or payment behavior (e.g., payment with large bills, requests to get cash back) may be used to determine what payment instrument to suggest and/or the notification.

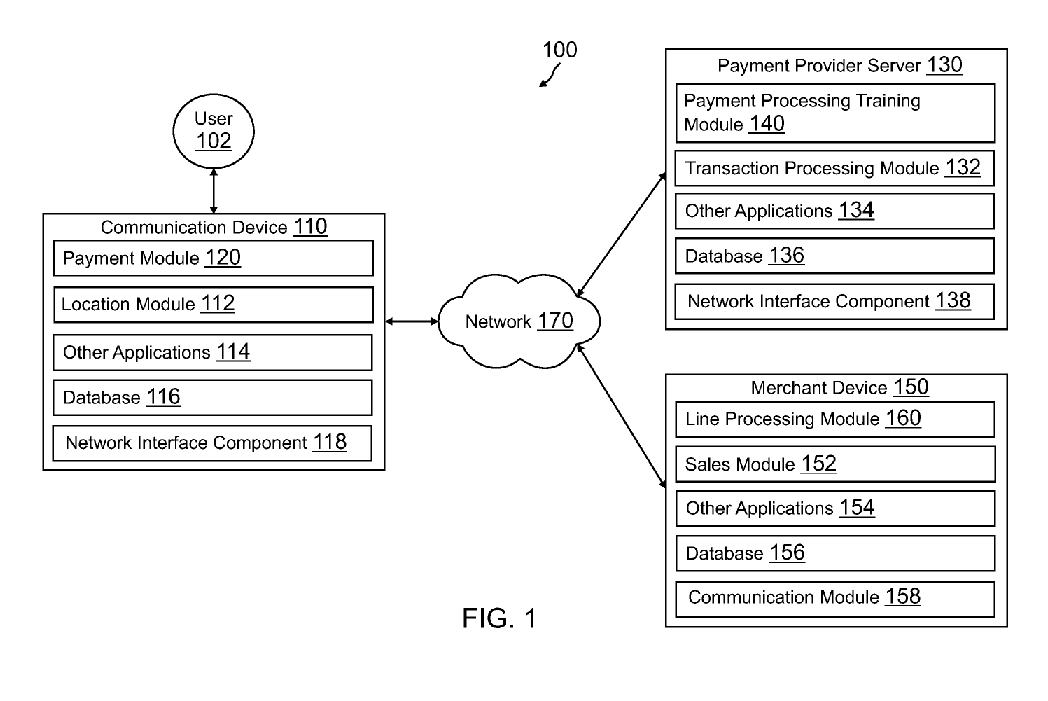

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, a payment provider server 130, and a merchant device 150 in communication over a network 170. User 102 may utilize communication device 110 to utilize the various features available for communication device 110, which may include processes to access and use services offered by payment provider server 130 (e.g., payment services). User 102 may bring communication device 110 to a merchant location having merchant device 150, as well as other merchant devices, which may be used for payment processing (e.g., a point-of-sale device). The merchant location may include a checkout location having a plurality of checkout lines or a merchant location having only one checkout line. Merchant device 150 may detect user 102 at or nearby the checkout location and ready to complete a transaction at the checkout location. Merchant device 150 may be used to determine a checkout line for user 102 based on merchant employee familiarity with using a payment instrument (e.g., a mobile device application) available to user 102. In further embodiments, merchant device 150 may also provide payment processing instructions to a merchant employee and assist user 102 in selecting one of the available payment instruments to user 102 based on a merchant employee's familiarity with the payment instruments. Training information and/or payment processing instruction may be available from payment provider server 130, which may also perform processing of payments for transactions.

Communication device 110, payment provider server 130, and merchant device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented as a communication device that may utilize appropriate hardware and software configured for wired and/or wireless communication with payment provider server 130 and/or merchant device 150. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains a payment module 120, a location module 112, other applications 114, a database 116, and a communication module 118. Payment module 120, location module 112, and other applications 114 may correspond to executable processes, procedures, and/or applications with associated hardware. In other embodiments, communication device 110 may include additional or different modules having specialized hardware and/or software as required.

Payment module 120 may correspond to one or more processes to execute modules and associated devices of communication device 110 to initiate, receive, and/or process/complete transactions with a merchant corresponding to merchant device 150, as well as receive notifications from merchant device 150 regarding checkout line and payment instrument selection. In this regard, payment module 120 may correspond to specialized hardware and/or software utilized by communication device 110 to provide a convenient interface to permit user 102 to select payment options and provide payment for items, for example, to a merchant associated with merchant device 150 using payment provider server 130. Payment module 120 may be implemented as a user interface enabling user 102 to enter payment options for storage by communication device 110, provide those payment options on checkout/payment of one or more items with the merchant corresponding to merchant device 150, and complete a transaction for the item(s) through a payment request for the item(s). In various embodiments, payment module 120 may include a general browser application configured to retrieve, present, and communication information over the Internet (e.g., utilize resource on the World Wide Web) or a private network. For example, payment module 120 may provide a web browser, which may send and receive information over network 170, including retrieving website information, presenting the website information to user 102, and/or communicating information to the website, including payment information. However, in other embodiments, payment module 120 may include a dedicated application of payment provider server 130 or other entity (e.g., a merchant), which may be configured to assist in processing payment requests.

Thus, user 102 may browse items for sale at a physical location, such as a merchant location corresponding to merchant device 150. User 102 may select an item for purchase and generate or receive a payment request for a transaction to purchase the item using payment module 120. For example, user 102 may wish to complete the transaction to purchase the item by visiting a checkout location within the merchant location. The checkout location may include a plurality of checkout lines, each having a merchant device (e.g., merchant device 150) and a corresponding merchant employee performing payment processing for transactions. User 102 may utilize payment module 120 to generate a payment request for the item(s) and provide or identify payment information to complete the transaction when checking out with merchant device 150 in one of the checkout lines. Payment module 120 may utilize user financial information, such as a credit card, bank account, or other financial account, as a payment instrument when providing payment information for use in a payment request. Additionally, payment module 120 may utilize a user account with payment provider, such as payment provider server 130, as the payment instrument. Payment provider server 130 may therefore provide payment processing. The payment request may be communicated to payment provider server 130 for processing to complete the transaction for the item using the user financial information. In various embodiments, the payment request may be communicated to a merchant server or device (e.g., as a payment token for the item) directly (e.g., using short range wireless communications) or over network 170 for communication to payment provider server 130, or may be communicated to payment provider server 130 over network 170 (e.g., as a payment token including merchant identification for payment to the merchant selling the item). The payment request may include identification of the transaction and a request to purchase the items in the transaction.

Payment module 120 may also provide information indicating that user 102 would like to use payment module 120 and/or a payment instrument accessible/usable by payment module 120 when paying for a transaction, for example, to merchant device 150 for processing, as discussed herein. Such information may be provided as a selected preference by user 102 in a menu interface for payment module 120 and/or an operating system of communication device 110. In other embodiments, merchant device 150 may determine that payment module 120 is open and/or active on merchant device 150, and/or that user 102 has selected a payment instrument available within payment module 120 while payment module 120 is active on communication device 110. Thus, payment module 120 may provide the information to merchant device 150 on request by merchant device 150 when merchant device 150 detects user 102 as located at or nearby the checkout location within the merchant location for merchant device 150.

Payment module 120 may also be used to receive line guidance information from merchant device 150 (e.g., notifications) and payment instrument suggestions from merchant device 150. A notification having line guidance information for a selected checkout line may be received from merchant device 150 based on a payment instrument selected and/or available to user 102, as discussed herein. Similarly, other notifications may be directed to suggestions of a payment instrument to use within a certain checkout line based on the checkout line's merchant employee and their familiarity with user 102's available payment instrument. Once received, payment module 120 may display the notification to user 102 while user 102 is at the checkout location so that user 102 may make checkout line and payment instrument selections. If user 102 wishes to use a certain payment instrument after another payment instrument is suggested by merchant device 150, payment module 120 may communicate the selection of payment instrument by user 102 to merchant device 150.

Location module 112 may correspond to one or more processes and/or specialized hardware of communication device 110 to determine a location for user 102, which may include detection of user 102's location through mapping and/or GPS devices as well as utilizing short range wireless communications to connect with nearby devices. In this regard, location module 112 may correspond to specialized hardware and/or software that may determine a location for user 102 while user 102 is within a merchant location corresponding to merchant device 150 that includes a checkout location having one or more checkout lines. Thus, location module 112 may be used to determine when user 102 is at or nearby the checkout location within the merchant location and/or within one of the plurality of checkout lines. Location module 112 may correspond to a mapping or GPS module, which may be used to determine a location for user 102 and communicate the location to merchant device 150. Such location information may correspond to coordinates for user 102 and/or a map location for user 102.

However, in other embodiments, location module 112 may be used to determine that user 102 is at or nearby a checkout location or within a checkout line of the checkout location using short range wireless communications between communication device 110 and merchant device 150, a wireless beacon, or other device located within the checkout location. For example, location module 112 may use communication module 118 of communication device 110 to pair with a device (e.g., merchant device 150, a wireless beacon, etc.) established within the checkout location or specific checkout lines in the checkout location. The devices may pair using short range wireless communications, such as near field communication, Bluetooth, Bluetooth Low Energy, LTE Direct, radio, infrared, or other communication protocol. The connection may be established with or without user input from user 102. For example, merchant device 150 and/or a wireless beacon may broadcast a token, including a universally unique identifier (UUID), for reception by location module 112. Location module 112 may utilize communication module 118 of communication device 110 to receive the token. If location module 112 acknowledges the UUID as identifying merchant device 150, the merchant, and/or the wireless beacon, location module 112 may transmit an identifier or other user information corresponding to user 102 and/or communication device 110 back to merchant device 150 and/or the wireless beacon to identify user 102 as at or nearby the checkout location and/or located within a line of the checkout location. The identifier or other user information from communication device 110 may include, be transmitted with, concatenated with, or otherwise bundled with the identifier received from merchant device 150/the wireless beacon. Such connection may correspond to a check-in process that associates user 102 with the checkout location and/or checkout line for user 102. The communications may be range limited to the checkout location and/or a checkout line within the checkout location. In various embodiments, payment module 120 may utilize the link over short range wireless communications to provide merchant device 150 and/or the wireless beacon to provide information about selected payment instruments to merchant device 150. Thus, the wireless beacon may communicate the user information and any other received information to merchant device 150 over a wired connection or wirelessly using similar short range wireless communications.

In various embodiments, one or more the discussed hardware and/or software features of payment module 120 and location module 112 may be included in the same module.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications. Other applications may include social networking applications and/or merchant applications, including merchant marketplace and/or sales applications, which may be used with merchant device 150 during transaction processing. Other applications 114 may include device interfaces and other display modules that may receive input from user 102 and/or output information to user 102. For example, other applications 114 may contain software programs, executable by a processor, including a graphical user interface (GUI) configured to provide an interface to the user.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with payment module 120 and/or other applications 114, identifiers associated with hardware of communication device 110, or other appropriate identifiers, such as identifiers used for payment/user/device authentication or identification. Database 116 may include user information, including preferred payment instruments, location information, and/or other information used by merchant device 150 for checkout line and payment instrument suggestion and/or direction. Additionally, notifications and other received information may be stored to database 116

Communication device 110 includes at least one communication module 118 adapted to communicate with payment provider server 130 and/or merchant device 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Payment provider server 130 may be maintained, for example, by an online payment service provider, which may provide payment services and/or processing for financial transactions on behalf of users. In this regard, payment provider server 130 includes one or more processing applications which may be configured to interact with communication device 110, merchant device 150, and/or another device/server to facilitate payment for a transaction. Additionally, payment provider server 130 may provide training for use of associated payment instruments by merchant employees during checkout, including a mobile device application, such as payment application 120. Payment provider server 130 may provide direct training, for example, through one or more applications available on a website for payment provider server 130. In other embodiments, payment provider server 130 may offer real-world training sessions. In one example, payment provider server 130 may be provided by PAYPAL®, Inc. of San Jose, Calif., USA. However, in other embodiments, payment provider server 130 may be maintained by or include a credit provider, financial services provider, financial data provider, and/or other service provider, which may provide payment services to user 102.

Payment provider server 130 of FIG. 1 includes a payment processing training module 140, a transaction processing module 132, other applications 134, a database 136, and a network interface component 138. Transaction processing module 132 and other applications 134 may correspond to executable processes, procedures, and/or applications with associated hardware. In other embodiments, payment provider server 130 may include additional or different modules having specialized hardware and/or software as required.

Payment processing training module 140 may correspond to one or more processes to execute modules and associated specialized hardware of payment provider server 130 to provide payment training and payment processing instructions over network 170 and/or track payment processing training that one or more merchant employees has initiated and/or completed. In this regard, payment processing training module 140 may correspond to specialized hardware and/or software to provide training videos, instructions, walkthroughs, and/or interactive systems that a merchant employee corresponding to merchant device 150 may use during training and education in payment processing using a payment instrument provided by payment provider server 130. As discussed herein, the payment instrument may correspond to a mobile payment application on communication device 110, such as payment module 120, or may correspond to physical payment instruments, including payment cards. The merchant employee may access payment processing training module 140 to receive the training. Moreover, payment provider server 130 may provide real-world training, for example, using one or more persons or entities that provide payment processing training. Payment processing training module 140 may track a merchant employee's training assessment or level, for example, based on a number of training session, depth of training sessions, progression through a training system, or other metric, which may be provided to merchant device 150 during determination of the merchant employee's familiarity level with the payment instrument.

Moreover, payment processing training module 140 may provide payment processing instructions, tips, and/or walkthroughs, which may be presented on merchant device 140 during processing of a payment using a payment instrument corresponding to the payment processing instructions. For example, merchant device 150 may determine that user 102 wishes to use a specific payment instrument corresponding to payment provider server 130 during a payment for a transaction in a checkout line corresponding to a merchant employee. Merchant device 150 may further determine that based on the merchant employee's familiarity with the payment instrument, the merchant employee may require payment processing instructions for the payment instrument. Thus, merchant device 150 may access the instructions from payment processing training module 140. However, in other embodiments, the instructions, tips, walkthroughs, and/or interactive systems providing payment processing instructions or assistance may be stored local to merchant device 150 instead of accessed from payment processing training module 140.

Transaction processing module 132 may correspond to one or more processes to execute modules and associated specialized hardware of payment provider server 130 to receive and/or transmit information from communication device 110 for establishing payment accounts for user 102, processing and completing of one or more transactions initiated by user 102 using the payment accounts, and providing payment instruments associated with the payment accounts, including mobile device applications. In this regard, transaction processing module 132 may correspond to specialized hardware and/or software to establish payment accounts, which may be utilized to send and receive payments and monetary transfers and engage in other financial transactions. User 102 may establish a payment account with transaction processing module 132 by providing personal and/or financial information to payment provider server 130 and selecting an account login, password, and other security information. The payment account may be accessed through a browser application and/or dedicated payment application executed by communication device 110, such as an application associated with payment module 120. Thus, user 102 may provide a payment for a transaction using a mobile device application local to communication device 110 that assists in performing a payment to the merchant associated with merchant device 150. In other embodiments, the payment account may be linked to a payment card or other physical payment instrument, which may similarly include transaction processing training and/or instructions as discussed in reference to payment processing training module 140.

Transaction processing module 132 may further process a received transaction from communication device 110 and/or merchant device 150 by receiving the transaction a payment request for a payment for the transaction. The payment request may correspond to a payment token, including a payment instrument and identification of the transaction, and may be encrypted prior to transmission to transaction processing module 132 to prevent unauthorized receipt of a payment instrument. The payment token may include information corresponding to user identifiers, user financial information/identifiers, transaction information and/or other identifiers. Additionally, the payment token may include a payment amount and terms of payment for the transaction. Once the transaction is received and user 102 is authenticated, transaction processing module 132 may utilize a payment account or financial information (e.g., a payment instrument such as a credit/debit card, bank account, etc.) of user 102 to render payment for the transaction. Payment may be made to merchant device 150 or another user device using the payment instrument and the terms of the payment request, or may be made to an account for a merchant associated with merchant device 150. Additionally, transaction processing module 132 may provide transaction histories, including receipts, to communication device 110 and/or merchant device 150, or may store the transaction histories to the user's account and/or the merchant's account.

In various embodiments, payment provider server 130 includes other applications 134 as may be desired in particular embodiments to provide features to payment provider server 134. For example, other applications 134 may include security applications for implementing server-side security features, programmatic client applications for interfacing with appropriate application programming interfaces (APIs) over network 170, or other types of applications. Other applications 134 may contain software programs, executable by a processor, including a graphical user interface (GUI), configured to provide an interface to user 102 when accessing payment provider server 130. In various embodiments where not provided by transaction processing module 132 and/or payment processing training module 140, other applications 134 may include connection and/or communication applications, which may be utilized to communicate information to over network 170.

Additionally, payment provider server 130 includes database 136. As previously discussed, user 102 and/or the merchant corresponding to merchant device 150 may establish one or more payment accounts with payment provider server 130. Payment accounts in database 136 may include user/merchant information, such as name, address, birthdate, payment/funding information, additional user financial information, and/or other desired user data. User 102 and/or the merchant may link to their respective payment accounts through a user, merchant, and/or device identifier. Thus, when an identifier is transmitted to payment provider server 130, e.g. from communication device 110 and/or merchant device 150, a payment account belonging to user 102 and/or the merchant may be found. Payment amounts may be deducted from one payment account and paid to another payment account. In other embodiments, user 102 and/or the merchant may not have previously established a payment account and may provide other financial information to payment provider server 130 to complete financial transactions, as previously discussed. Additionally, database 136 may include stored information for payment processing, including payment requests and transaction information. Information used by payment processing training module 140 may also be stored to database 136, including training information for merchant employees and instructional information for use during payment processing.

In various embodiments, payment provider server 130 includes at least one network interface component 138 adapted to communicate communication device 110 and/or merchant device 150 over network 170. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

A physical merchant location may merchant device 150, which may correspond to a point of sale (POS) and/or check-out machine/device. The merchant location may include sub-locations, such as a checkout location where users may purchase goods, products, services, and/or other types of purchasable (collectively referred to as an “item” or “items” herein). The checkout location may include one or more checkout lines where users may be provided service by merchant employees utilizing merchant device 150 and/or other merchant devices. Thus, the merchant location may include a plurality of merchant devices functioning similar to merchant device 150. Moreover, the merchant location may be associated with a merchant server, which may perform some or all of the below described functions with respect to merchant device 150. Merchant device 150 may be maintained, for example, by a merchant or seller offering various items, products, and/or services through the physical merchant location. Generally, merchant device 150 may be maintained by anyone or any entity that receives money, which includes charities as well as retailers and restaurants. In this regard, merchant device 150 may include a device having processing applications, which may be configured to interact with communication device 110 and/or payment provider server 130 to facilitate the sale of items.

Merchant device 150 may be implemented using any appropriate hardware and software configured for wired and/or wireless communication with communication device 110 and/or payment provider server 130. For example, in one embodiment, merchant device 150 may be implemented as a single or networked personal computer (PC), a smart phone, laptop computer, wearable computing device, and/or other types of computing devices at a merchant location capable of transmitting and/or receiving data. Although a merchant device is shown, the merchant device may be managed or controlled by any suitable processing device, including merchant servers and cloud computing resources. Although only one merchant device is shown, a plurality of merchant devices may function similarly.

Merchant device 150 of FIG. 1 contains a line processing module 160, sales module 152, other applications 154, a database 156, and a communication module 158. Sales module 152 and other applications 154 may correspond to processes, procedures, and/or applications executable by a hardware processor, for example, a software program. In other embodiments, merchant device 150 may include additional or different modules having specialized hardware and/or software as required.

Line processing module 160 may correspond to one or more processes to execute modules and associated specialized hardware of merchant device 150 to determine that user 102 is at or nearby a checkout area or a specific checkout line based on received user information, determine a payment instrument for use by user 102 where user 102 has indicated the payment instrument will be used during payment processing, determine an optimized line for user 102 based on merchant employee's familiarity level with the payment instrument, determine a payment instrument for use by user 102 based on the merchant's familiarity level where applicable, and provide notifications for the user based on the familiarity level and the aforementioned determined information. In this regard, line processing module 160 may correspond to specialized hardware and/or software of merchant device 150 that may first determine that user 102 will checkout for a transaction at a merchant location based on a location for the user within the merchant location. Thus, line processing module 160 may access user information for user 102 that indicates user 102 is at or nearby a checkout location within a merchant location for a merchant corresponding to merchant device 150. The checkout location may include a plurality of checkout lines, each served by a merchant employee performing checkout for users, such as processing payments for transactions by the users. Thus, line processing module 160 may determine an optimized checkout line for user 102 based on user 102's selected payment instrument, which may be optimized for fastest payment processing by the merchant employee and/or payment processing assistance and troubleshooting by the payment employee.

After determining that user 102 is at or nearby the checkout location, line processing module 160 may further determine what payment instrument user 102 will use for a payment for a transaction between user 102 and the merchant corresponding to merchant device 150. In this regard, line processing module 160 may access the user information, which may include an indication of the payment instrument. For example, the user information may include a preference by user 102 set with payment module 120 to use payment module 120 and/or a payment instrument available to payment module 120. In other embodiments, the information may be scraped information from communication device 110 and/or over network 170, such as currently available and/or open applications on communication device 110 (e.g., payment module 120) or online postings and transaction information indicating that user 102 has used a certain payment instrument for previous transactions. Once line processing module 160 has determined a payment instrument for user by user 102, line processing module 160 may access merchant employee information indicating a familiarity level for each of the available merchant employees at the plurality of checkout lines.

Thus, merchant employee information may include familiarity levels for each of a plurality of merchant employees that determine each merchant employee's training, speed of processing, available assistance or troubleshooting ability, or other familiarity indicator with using a specific payment instrument for processing a payment for a transaction. A familiarity level may be linked to a specific payment instrument; therefore, each merchant employee may have a plurality of associated familiarity levels for a plurality of different payment instruments. A familiarity level may correspond to a level, ranking, score, or other determinable metric determined using the amount of training a merchant employee has with using a payment instrument for payment processing, a level or rating (e.g., tier 3, gold certified, master level, etc.) based on completed training, an average or weighted time to process a payment using the payment instrument, customer and/or management reviews of the merchant employee's ability to process a payment using the payment instrument, and/or a number of transactions the merchant employee has completed using the payment instrument to process payments for the transactions. The familiarity level may be calculated based on a mix of one or more of the aforementioned factors, and may various factors may be given different weighted scores within the calculation of the familiarity level. Data for each of the factors may be received and stored by merchant device 150 based on input data or data accessible over network 170, for example, from payment processing training module 140. The familiarity level for a merchant employee with a payment instrument may then be stored with the merchant employee information and accessible in determining a checkout line for user 102. Additionally, line processing module 160 may further access line information, which may include a wait time for each of the plurality of checkout times and/or a current number of users within each of the plurality of checkout lines.

Based on the user information and the familiarity levels for each of the merchant employees at the checkout location with the payment instrument for use by user 102 (as well as additional line information), line processing module 160 may determine which checkout line user 102 should use. Line processing module 160 may determine a checkout line with a merchant employee having a highest familiarity level for the payment instrument so that the merchant employee knows how to process the payment instrument. In other embodiments, the merchant employee may be selected as long as the merchant employee meets a threshold familiarity level. The merchant employee may be selected as the merchant employee having the fastest processing time for the payment instrument and/or the merchant employee that may have the highest amount of training from troubleshooting payment issues during payment processing and guiding user 102 through the payment process using the payment instrument. For example, user 102 accustomed to using the payment instrument may wish to complete a fast checkout, while another user that has not previously or rarely used the payment instrument may wish to have a merchant employee that is very knowledgeable about the payment instrument assist in the payment process. Line processing module 160 may generate a notification directing user 102 to the checkout line determined by line processing module 160 and communicate the notification to communication device 110. In various embodiments, a display device located at the checkout location may also display the notification.

In other embodiments, the user location may be used to determine that user 102 is located within a specific checkout line of the merchant location. Thus, user 102 information may further be used to determine a merchant employee that will be assisting user 102 during checkout, for example, by processing a payment for a transaction between user 102 and the merchant corresponding to merchant device 150. If user 102 has selected a payment instrument, line processing module 160 may determine the merchant employee's familiarity level for that payment instrument that will assist user 102 in the checkout line that user 102 is located within. Based on that familiarity level, line processing module 160 may access payment processing instructions, for example, from payment provider server 130 and/or stored to database 156. Line processing module 160 may display the instructions to the merchant employee during processing a payment for user 102 using the payment instrument to assist the merchant employee with processing the payment. For example, if the familiarity level includes a training assessment that that indicates the merchant employee is unfamiliar with the payment instrument, the instructs may include an instructional guide on processing payments using the mobile payment application and/or a payment interface of the merchant device that provides an interactive walkthrough of processing the payment. However, if the merchant employee is familiar with the payment instrument and has an average or weighted speed for processing payments using the payment instrument, the instructions may include tips for faster processing time when using the payment instrument and a payment interface walkthrough for a corresponding payment application on the merchant device for use with the mobile payment application. Thus, the payment processing instructions may be customized to the merchant employee. Moreover, if the merchant employee is very unfamiliar with the payment instrument or has a very long processing time, line processing module 160 may determine another merchant employee having a highest familiarity level, and direct that merchant employee to assist the merchant employee currently processing a payment for user 102 using user 102's payment instrument.

However, if user 102 has selected a checkout line and is determined to be located in the checkout using the user information for user 102, but has yet to select a payment instrument, line processing module 160 may access the merchant employee information to determine all of the familiarity levels for the merchant employee assisting that line. Line processing module may also determine what payment instruments are available to user 102, for example, payment module 120 and/or processes and instruments available to payment module 120, as well as physical payment instruments. Line processing module 160 may then determine a “best” payment instrument for user 102 associated with a highest familiarity level for the merchant employee with all of the available payment instruments to user 102. A notification may be generated and communicated to communication device 110 for display to user 102 including the suggested payment instrument. If user 102 wishes to use another payment instrument, user 102 may select another payment instrument, where an alert may be communicated back to merchant device 150 informing the merchant employee that user 102 will use a different payment instrument.

Sales module 152 may correspond to one or more processes to execute modules and associated specialized hardware of merchant device 150 that provide checkout and payment processes, which may be configured to complete transactions for items. In this regard, sales module 152 may correspond to specialized hardware and/or software of merchant device 150 to provide a convenient interface to permit a merchant to enter, view, and/or edit items and/or services for purchase by user 102. For example, sales module 152 may be implemented as an application having a user interface enabling the merchant to enter item information and request payment for a transaction on checkout/payment of one or more items/services. In certain embodiments, sales module 152 may correspond more generally to a web browser configured to view information available over the Internet or access a website corresponding to the merchant and/or payment provider server 130.

Once a payment amount is determined for a transaction for items to be purchased by user 102, sales module 152 may request payment from user 102. Payment module 120 and sales module 152 may interact to complete payment using a payment instrument, for example, a payment account provided by payment provider server 130, as discussed herein. Sales module 152 may be used to determine a payment instrument for user 102 on presentation of the payment instrument. For example, when user 102 wishes to use a mobile device application (e.g., payment module 120), sales module 152 may receive information indicating user 102 wishes to pay using payment module 120 as a payment instrument, which may be utilized by line processing module 160. Sales module 152 may further display payment processing instructions during processing of a payment for a transaction, for example, walkthroughs, interactive interfaces, instructions, and/or tip for completing a payment using payment module 120 with sales module 152. Sales module 152 may communicate a received payment request to payment provider server 130 or other payment gateway, and receive payment and/or confirmation of payment/transfer of funds. Such confirmation may include transaction histories, such as receipts.

Merchant device 150 includes other applications 154 as may be desired in particular embodiments to provide features to merchant device 150. For example, other applications 154 may include security applications for implementing client-side security features, programmatic client applications for interfacing with appropriate application programming interfaces (APIs) over network 170, or other types of applications. Other applications 154 may also include email, texting, voice and IM applications that allow a user to send and receive emails, calls, texts, and other notifications through network 170. In various embodiments, other applications 154 may include financial applications, such as banking, online payments, money transfer, or other applications associated with payment provider server 130. Other applications 134 may contain software programs, executable by a processor, including a graphical user interface (GUI) configured to provide an interface to the user.

Merchant device 150 may further include database 156 which may include, for example, identifiers such as operating system registry entries, cookies associated with sales module 152 and/or other applications 154, identifiers associated with hardware of merchant device 150, or other appropriate identifiers, such as identifiers used for payment/user/device authentication or identification. Identifiers in database 156 may be used by a payment/credit provider, such as payment provider server 130, to associate merchant device 150 with a particular account maintained by the payment/credit provider. Database 156 may further include a transaction between user 102 and a merchant corresponding to merchant device 150, as well as transaction information. Additionally, merchant employee information having familiarity levels, payment processing training, and/or payment processing instructions may be stored to database 156.

Merchant device 150 includes at least one communication module 158 adapted to communicate with communication device 110 and/or payment provider server 130. In various embodiments, communication module 158 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. In various embodiments, merchant device 150 may include a communication module, which may communicate directly with communication device 110 using short range wireless communications, such as radio frequency, infrared, Bluetooth, and near field communications.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

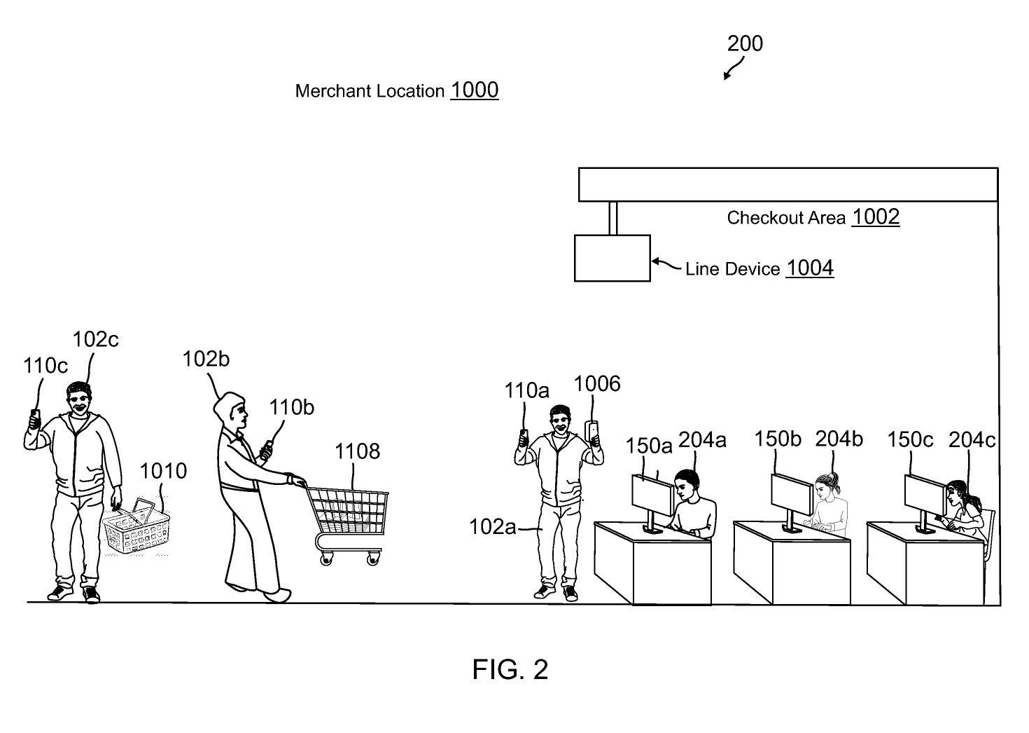

FIG. 2 is an environment where merchant employees may receive instructions for payment processing using payment instruments and users may be guided to a specific merchant checkout lines based on their payment instruments, according to an embodiment. Environment 200 includes a user 102a having a communication device 110a, a user 102b having a communication device 110b, and a user 102c having a communication device 110c all corresponding generally to user 102 having communication device 110, respectively, from environment 100 of FIG. 1. Moreover, environment 200 includes merchant device 150s, a merchant device 150b, and a merchant device 150c all corresponding generally to merchant device 150 from environment 100 of FIG. 1.

In environment 200, a merchant location 1000 may include a checkout area 1002 where users 102a-c may provide payments for transaction with a merchant associated with merchant location 1000. Checkout location 1002 includes a merchant employee 204a, a merchant employee 204b, and a merchant employee 204c, each of which may be located at separate checkout lines within checkout area 1002. In environment 200, user 102a may bring an item 1006 to merchant employee 204a in order to provide payment for item 1006 through a mobile device application of communication device 110a. Checkout area 1002 may further include a line device 1004, which may detect user 102a as within a checkout line for merchant employee 204a. In other embodiments, one or more of merchant device 150a-c may detect user 102a as located nearby checkout area 1002.

On detection of user 102a approaching or at the checkout line for merchant employee 204a, line device 1004 and/or merchant device 150a may receive user information indicative of a payment instrument that user 102a wishes to use to pay for item 1006. Once merchant device 150a determines that user 102a wishes to pay using a mobile device payment application of communication device 110a, merchant device 150a may determine merchant employee 204a's familiarity level with using the mobile device payment application on communication device 110a to process a payment for a transaction for item 1006. Based on the familiarity level, merchant device 150a may load customized payment processing instructions and display the instruction to merchant employee 204c during processing of the payment. Thus, merchant employee 204a may assist user 102a with quickly and efficiently completing payment using communication device 110a and merchant device 150a. Similarly, in embodiments, where the mobile device payment application on communication device 110a includes multiple payment instruments and/or communication device 110a includes multiple payment applications, merchant device 150a may determine a payment instrument for user 102a to use based on merchant employee 204a's familiarity levels with each of the payment instruments available to user 102a.

However, users 102b and 102c are shown as approaching checkout area 1002 but have yet to pick a checkout line. Users 102b and 102c may be detected as approaching checkout area 1002 when user information is received for users 102b and 102c. The user information may include location information or may be used to determine users 102b's and 102c's location based on short range wireless communications with a device (e.g., line device 1004 and/or merchant devices 150a-c). Once detected, merchant devices 150a-c may determine a payment instrument that user 102b wishes to use for a payment for cart items 1008 and a payment instrument that user 102c wishes to use for basket items 1010. For example, user 102b may wish to use a first payment application available on communication device 110b. One or more of merchant devices 150a-c may access merchant employee information having familiarity levels for merchant employees 204a-c with the first payment application. Merchant devices 150a-c may then determine that merchant employee 204b has the highest familiarity rating with the first payment application, and may generate a notification directing user 102b to the checkout line for merchant employee 204b. The notification may be communicated to communication device 110b for display and/or displayed through line device 104. Similarly, one or more of merchant devices 150a-c may determine that user 102c will use a second payment application on communication device 110c and direct user 102c to merchant employee 204c, who has the highest familiarity level with processing payments using the second payment application.

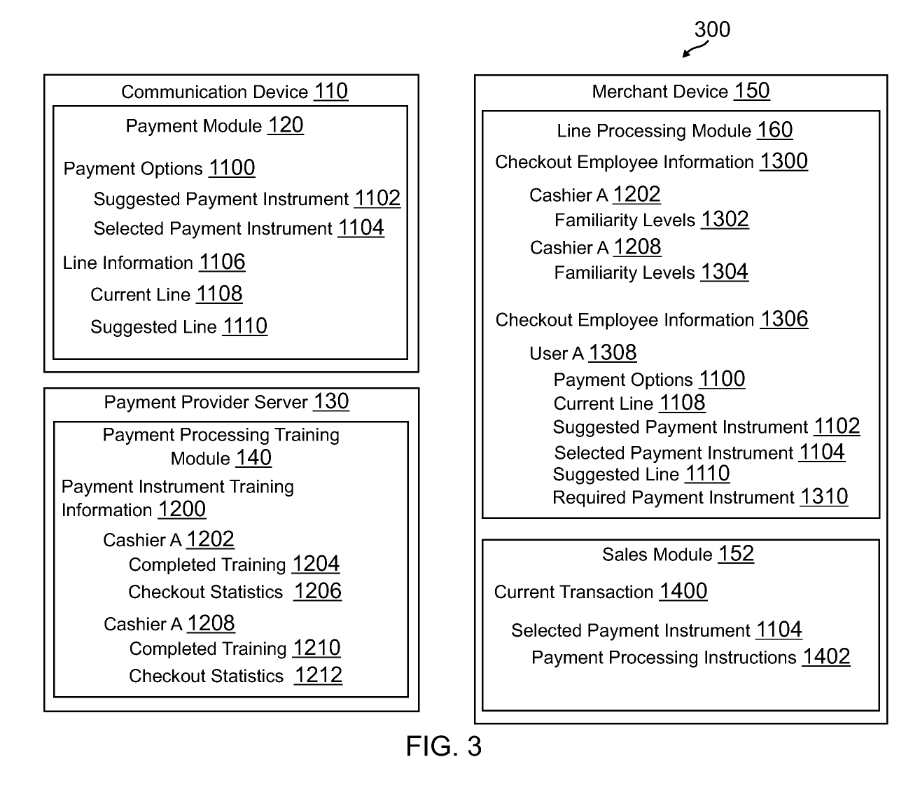

FIG. 3 is an exemplary interaction between a communication device, a payment provider server, and a merchant device for determining a checkout line to direct a user for payment processing, according to an embodiment. Environment 300 of FIG. 3 includes communication device 110, a payment provider server 130, and a merchant device 150 from environment 100 of FIG. 1 executing module and processes discussed in reference to environment 100.

Merchant device 150 executes line processing module 160 and sales module 152 corresponding generally to the specialized hardware and/or software modules and processes described in reference to FIG. 1. In this regard, line processing module 160 may determine a checkout line and/or payment instrument for use by a user associated with communication device 110 (not shown). Thus, line processing module 160 includes checkout employee information 1300 and current customer information 1306. Checkout employee information 1330 may include familiarity levels for merchant employees, for example, familiarity levels 1302 for cashier A 1202 and familiarity levels 1304 for cashier B 1208. Familiarity levels 1302 and 1304 may both include one or more familiarity levels each associated with a payment instrument. Familiarity levels 1302 and 1304 may be associated with a rating, level, score, or other assessment metric with cashier A 1202's and cashier B 1208's, respectively, ability to process payments using the payment instrument.

Current customer information 1306 may include user information detected for a user at or nearby a checkout location. For example, user A 1308 may be detected at or nearby the checkout location. User A 1308 further includes payment options 1100, which may include payment instruments available to user A 1308. User A 1308 may also be associated with information for a current line 1108 and a selected payment instrument 1104. Using the aforementioned information, line processing module 160 may determine suggested payment instruments 1102, suggested line 1110, and/or required payment instructions 1310 for a merchant employee.

Communication device 110 executes payment module 120 corresponding generally to the specialized hardware and/or software modules and processes described in reference to FIG. 1. In this regard, payment module 120 may be used as a payment instrument to provide a payment for a transaction. Thus, payment module 120 includes payment options 1100, which may be used to provide the payment. Payment module 120 may display suggested payment instrument 1102 determined by line processing module 160, as well as selected payment instrument 1104 required by the user of communication device 110 when providing the payment. Payment module 120 may further include line information 1106, which may have a current line 1108 for the user and a suggested line 1110 determined by line processing module 160.

Payment provider server 130 executes payment processing training module 140 corresponding generally to the specialized hardware and/or software modules and processes described in reference to FIG. 1. In this regard, payment processing training module 140 may provide information used to determine familiarity levels 1302 and 1304 for cashier A 1202 and cashier B 1208, respectively. Thus, payment processing training module 140 includes payment instrument training information 1200, which may include information for cashier A 1202 and cashier B 1208. Cashier A 1202 may be associated with completed training 1204 and checkout statistics 1206. Similarly, Cashier A 1208 may include completed training 1210 and checkout statistics 1212.

Sales module 152 may be used to complete a transaction by processing a payment from payment module 120. Thus, sales module 152 includes a current transaction 1400. Payment options 1100 may be used to provide the payment. Thus, current transaction 1400 includes selected payment instrument 1104 from payment module 120. Sales module 142 may further include payment processing instructions 1402 from line processing module 160, which may be displayed to a merchant employee during processing of current transaction 1400.

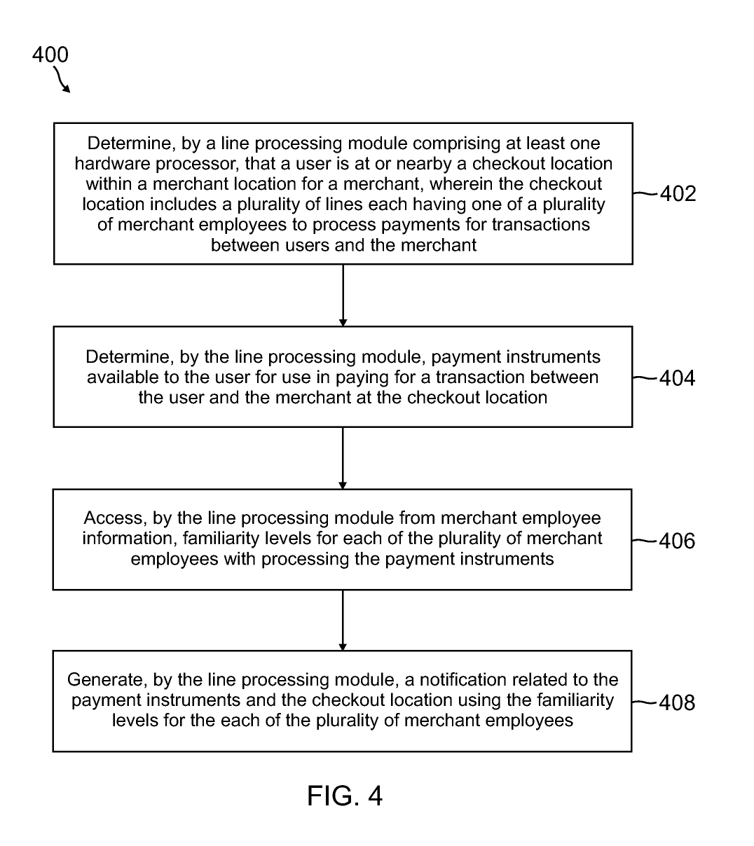

FIG. 4 is a flowchart of an exemplary process for checkout line processing based on merchant employee familiarity with communication device processes, according to an embodiment. Note that one or more steps, processes, and methods described herein may be omitted, performed in a different sequence, or combined as desired or appropriate.

At step 402, it is determined, by a line processing module comprising at least one hardware processor, that a user is at or nearby a checkout location within a merchant location for a merchant, wherein the checkout location includes a plurality of lines each having one of a plurality of merchant employees to process payments for transactions between users and the merchant. In various embodiments, this may further include determining that the user is further using a specific one of the checkout lines, or with a merchant location having only one checkout line. However, in other embodiments, the user may not have selected a checkout line when arriving at the checkout location. User information may be received from one of the communication device using short range wireless communication and a wireless beacon established near the checkout location and in communication with the communication device using the short range wireless communication in order to determine the user is at the checkout location and/or within the checkout line. The user information may also comprise at least one of a number of times the user has used the mobile device application, an assistance request within the mobile device application, and an average payment processing time by the user using the mobile device application

Payment instruments available to the user for use in paying for a transaction between the user and the merchant at the checkout location are determined, by the line processing module, at step 404. One or more of the payment instruments may comprise a mobile device application of the communication device that provides payments using a payment provider. In various embodiments, the line processing module may also determine what payment instrument the user will use during a payment for a transaction. However, in other embodiments, the line processing module may determine available payment instruments for use in suggesting a payment instrument to the user. Thus, at step 406, familiarity levels for each of the plurality of merchant employees with processing the payment instruments is accessed, by the line processing module from merchant employee information. Where the payment instrument is known to the line processing module, only the familiarity level for the payment instrument need to be accessed.

The familiarity levels may include information for at least one of an amount of training each of the plurality of merchant employees have with the payment instrument, a number of times each of the plurality of merchant employees have processed payments using the payment instrument, an average time to process payments using the payment instrument by each of the plurality of merchant employees, a weighted amount of time to process payments using the payment instrument by each of the plurality of merchant employees, and a training rating with the payment instrument by each of the plurality of merchant employees. Thus, a familiarity level for a specific payment instrument may comprise levels, rankings, scores, or other assessment metrics for one or more of a training assessment level of the merchant employee with using the payment instrument for processing payments, an average speed for processing the payment using the payment instrument by the first merchant employee, a weighted speed for processing the payment using the payment instrument by the first merchant employee, and a training assessment of the merchant employee with the payment instrument.

At step 408, a notification related to the payment instruments and the checkout location is generated, by the line processing module, using the familiarity levels for the each of the plurality of merchant employees. For example, the notification may direct the user to one of the plurality of checkout lines corresponding to one of the plurality of merchant employees having a highest familiarity level of the familiarity levels. In such embodiments, the selected line may be associated with a merchant employee having a highest familiarity level associated with the merchant employee having a lowest amount of time to process payments. In other embodiments, the highest familiarity level is associated with the merchant employee with a highest amount of training for troubleshooting payment issues during the payment and guiding the user through payment processing using the mobile device application. Additionally, the line processing module may access line information comprising at least one of a number of users in each of the plurality of checkout lines and a wait time for each of the plurality of checkout lines, wherein the line processing module further directs the user to the one of the plurality of checkout lines using the line information. The notification may also be communication to a display device at the checkout location for display to the user.

In other embodiments, the notification may comprise accessing payment processing instructions for the payment instrument based on the familiarity level and communication the instructions to a merchant device. The payment processing instructions may be personalized for the merchant employee based on the familiarity level. The payment processing instructions may comprise at least one of tips for faster processing time when using the payment instrument and a payment interface walkthrough for a corresponding payment application on the merchant device for use with the mobile payment application. If the merchant employee requires additional help, a second merchant employee having a highest familiarity level for the payment instrument and available for assistance during processing the payment for the transaction. The second merchant employee may be notified. The payment processing instruction may also be customized based on the user's information, for example, the user's past use of the payment instrument and past processing time for the payment instrument.

Moreover, the notification may also correspond to a selection of one of the available payment instruments for the user to use during payment. The payment instrument may be selected based on a highest familiarity level of a plurality of familiarity levels for the merchant employee with the available payment instruments. The notification may be communicated to the user one their communication device. Where the first user may request to use a second payment instrument instead of the selected payment instrument, the merchant employee may be alerted of the second payment instrument.

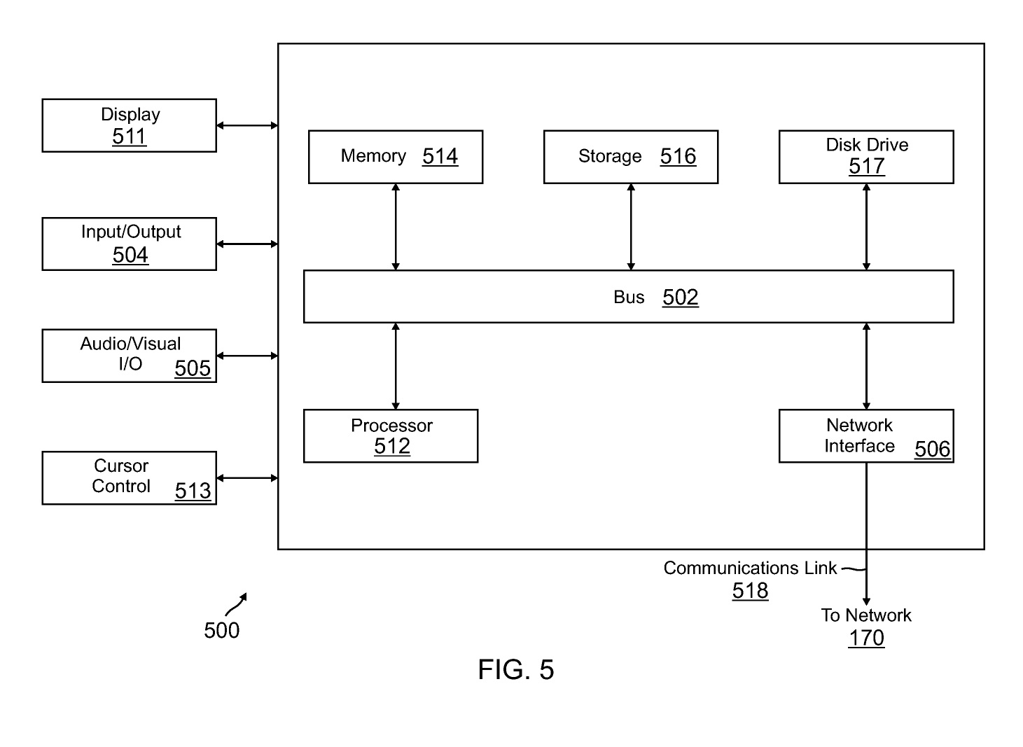

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a line processing module of a merchant device and comprising at least one hardware processor that determines that a user is at or nearby a checkout location within a merchant location using user information, wherein the checkout location includes a plurality of checkout lines each having one of a plurality of merchant employees, determines a payment instrument that the user will use for a payment for a transaction at the checkout location, accesses, from merchant employee information, familiarity levels for each of the plurality of merchant employees with using the payment instrument to process the payment for the transaction, and generates a notification for the user that directs the user to one of the plurality of checkout lines corresponding to one of the plurality of merchant employees having a highest familiarity level of the familiarity levels;
a database stored to a non-transitory memory that stores the user information, the merchant employee information for the plurality of merchant employees, and the notification; and
a communication module that receives the user information and communicates the notification to a communication device of the user

2. The system of claim 1, wherein the familiarity levels comprise at least one of an amount of training each of the plurality of merchant employees have with the payment instrument, a number of times each of the plurality of merchant employees have processed payments using the payment instrument, an average time to process payments using the payment instrument by each of the plurality of merchant employees, a weighted amount of time to process payments using the payment instrument by each of the plurality of merchant employees, and a training rating with the payment instrument by each of the plurality of merchant employees.

3. The system of claim 2, wherein the highest familiarity level associated with the one of the plurality of merchant employees having a lowest amount of time to process payments.

4. The system of claim 2, wherein the payment instrument comprises a mobile device application of the communication device that provides payments using a payment provider.

5. The system of claim 4, wherein the user information comprises at least one of a number of times the user has used the mobile device application, an assistance request within the mobile device application, and an average payment processing time by the user using the mobile device application.

6. The system of claim 1, wherein the highest familiarity level is associated with the one of the plurality of merchant employees with a highest amount of training for troubleshooting payment issues during the payment and guiding the user through payment processing using the mobile device application.

7. The system of claim 1, wherein the user information is received from one of the communication device using short range wireless communication and a wireless beacon established near the checkout location and in communication with the communication device using the short range wireless communication.

8. The system of claim 1, wherein the line processing module further accesses line information comprising at least one of a number of users in each of the plurality of checkout lines and a wait time for each of the plurality of checkout lines, and wherein the line processing module further directs the user to the one of the plurality of checkout lines using the line information.

9. The system of claim 1, wherein the communication module further communicates the notification to a display device at the checkout location for display to the user.

10. A method comprising:
determining, by a line processing module comprising at least one hardware processor, that a user is utilizing a checkout line at a checkout location within a merchant location for a merchant, wherein a first merchant employee is location at the checkout line to process transactions with users;
determining, by the line processing module, that the user will use a payment instrument for a payment for a transaction at the checkout line;
accessing, by the line processing module from merchant employee information stored to a database in a non-transitory memory, a familiarity level for the first merchant employee with using the payment instrument to process the payment for the transactions;
accessing, by the line processing module, payment processing instructions for the payment instrument based on the familiarity level; and
displaying, by the line processing module, the payment processing instructions to the first merchant employee on a merchant device.

11. The method of claim 10, wherein the payment instrument comprises a mobile payment application of a communication device in possession of the user.

12. The method of claim 11, wherein the familiarity level comprises a training assessment level of the first merchant employee with using the payment instrument for processing payments.

13. The method of claim 12, wherein payment processing instructions provide at least one of an instructional guide on processing payments using the mobile payment application and a payment interface of the merchant device that provides an interactive walkthrough of processing the payment.

14. The method of claim 13, wherein payment processing instructions are personalized for the first merchant employee based on the familiarity level.

15. The method of claim 11, wherein the familiarity level comprises at least one of an average speed for processing the payment using the payment instrument by the first merchant employee, a weighted speed for processing the payment using the payment instrument by the first merchant employee, and a training assessment of the first merchant employee with the payment instrument.

16. The method of claim 15, wherein payment processing instructions comprise at least one of tips for faster processing time when using the payment instrument and a payment interface walkthrough for a corresponding payment application on the merchant device for use with the mobile payment application.

17. The method of claim 10, further comprising:
accessing, by the line processing module from the merchant employee information, merchant contact information for a highest familiarity level for a second merchant employee available for assistance during processing the payment for the transaction;
notify the second merchant employee to assist the first merchant employee using the merchant contact information.

18. The method of claim 10, further comprising:
receiving user information for the user, wherein the user information comprises at least one of past use of the payment instrument by the user and past processing time for the payment instrument with payments by the user; and
customizing the payment processing instructions based on the user information.

19. A non-transitory computer-readable medium comprising executable modules which, in response to execution by a computer system, cause the computer system to perform a method comprising:
determining, by a line processing module comprising at least one hardware processor, that a user is utilizing a checkout line at a checkout location within a merchant location for a merchant, wherein a merchant employee is location at the checkout line to process transactions with users;
determining, by the line processing module, a plurality of payment instruments available to the user to use for a payment for a transaction at the checkout location;
determining, by the line processing module, a plurality of familiarity levels for the merchant employee with the plurality of payment instruments, wherein each of the plurality of familiarity levels corresponds to one of the plurality of payment instruments;
determining, by the line processing module, a first payment instrument of the plurality of payment instruments for the user to use for the payment based on a highest familiarity level of the plurality of familiarity levels;
generating, by the line processing module, a notification for the user that informs the user to use the first payment instrument; and
communicating the notification to a communication device of the user.

20. The non-transitory computer-readable medium of claim 19, wherein the method further comprises:
receiving a request to use a second payment instrument from the communication device of the user; and
alerting the merchant employee that the user will use the second payment instrument for the payment for the transaction.
